(19) United States
(12) Patent Application Publication
(10) Pub. No.: US 2015/0077540 A1
(43) Pub. Date: Mar. 19, 2015

(54) SYSTEM AND METHOD FOR DETERMINING GAS PERMEABILITY OF POLYMER FILMS BY MEANS OF IMAGE ACQUISITION

(71) Applicant: UNIVERSIDAD DE SANTIAGO DE CHILE, Santiago (CL)

(72) Inventors: Fernando Osorio Lira, Santiago (CL); Javier Enrione Caceres, Santiago (CL); Olivier Skurtys Bonny, Santiago (CL); Richardo Andrade Pizarro, Santiago (CL)

(73) Assignee: UNIVERSIDAD DE SANTIAGO DE CHILE, Santiago (CL)

(21) Appl. No.: 14/394,160

(22) PCT Filed: Apr. 12, 2013
(86) PCT No.: PCT/CL2013/000022

§ 371 Date: Oct. 13, 2014

(30) Foreign Application Priority Data
Apr. 12, 2012 (CL) 922-2012

(51) Int. Cl. G01N 15/08

(52) U.S. Cl. CPC G01N 15/0826; G01N 2015/0011
USPC 348/96

(57) ABSTRACT

System for determining gas permeability (O₂, CO₂, N₂, air) in films, especially edible films, wherein the system comprises a receptacle (A) containing a liquid of low solubility to the gas that is not reactive to it or dissolves the film; gas bubble generating means comprising a cylinder that contains the gas (G); a driver (E) that regulates gas flow and drives the syringe plunger (F); an image acquisition system comprising a high resolution camera (C); lighting (B) that uses a lighting means; and image processing means, preferably a computer program (D); and a method that comprises placing the liquid in an receptacle and letting the gas (G) flow, generating uniform bubbles in the liquid, and placing the film over the liquid; taking photographs or images for a determined time range and frequency and with an auxiliary lighting means; processing photographs or images in an image processing means, and determining variation in the bubbles volume at different times, wherein the bubble volume is determined based on the pixels corresponding to the bubble maximum diameter (Dₘₐₓ), the diameter of the contact area between bubble and film (A_{bp}) and the bubble height (h); correlating the number of pixels with a determined length measuring unit and calculating the variation in the gas bubble volume, (ΔV_{b}), the contact area between bubble and film (A_{bp}), and the pressure inside the bubble (ΔP); constructing the linear relationship of variation in the bubble volume in the course of time and from the slope of said linear relationship, calculating gas transmission rate, and then, permeability to gas.

### FIELD OF APPLICATION OF THE INVENTION

The principal field of application of the present invention is in the area of food packaging, Particularly, the present invention refers to a system and method for determining permeability of polymer films to gases by means of image acquisition.

### STATE OF THE ART

An important requirement in the selection of the food packaging system, particularly of fresh fruit or vegetables, is permeability of the material, which is the property of plastic films to allow the passage of gases or vapors through their molecular structure, either into or out of the package. Determination of the permeability of a polymer film generally involves measuring a change in gas pressure across the film. Pressure difference is caused by gas transfer through the membrane from a high pressure side to a low pressure side and needs specific equipment. Even if the principle is simple, these measurements are tiresome, time consuming and require expensive instruments.

The American Society of Testing and Materials (ASTM) specify three methods for measuring oxygen transmission through plastic films, these being: the manometric method (ASTM D1434), the volumetric method (ASTM D1434) and the method that uses coulometric sensor (ASTM D3985). The first two methods use absolute pressure differences. These methods imply the flow of an oxygen gas stream on one side of the film and a nitrogen stream, to carry the oxygen gas to the analyzer, on the other side. A coulometric sensor, an infrared sensor, a gas chromatograph or a gas analyzer (oxygen, carbon dioxide, etc.) are often used to determine the amount of gas that permeates the film. These methods require much time and costly instruments to perform their measurements; furthermore, they are inconvenient when what is required is to make determinations on edible films, which become brittle when subjected to a constant oxygen flow for an extended time.

The system for determining gas permeability of polymer films by image acquisition has the following advantages: reduction of measuring time, films are not subjected to oxygen flow for an long time which would eliminate the problem of film cracking; besides there is no need of expensive equipment for analyzing the amount of gas that penetrates the polymer film.

This invention consists in a system for determining gas permeability that comprises a receptacle (A) that contains the liquid, a gas bubble generator comprising a cylinder that contains the gas (C), a digital mechanical driver (E) that regulates gas flow and drives the syringe plunger (F), an image acquisition system comprising a high resolution camera (C), lighting (B) and a computer program (D) where images are processed.

To carry out the determination of gas permeability in films, a liquid is placed in the receptacle A; this liquid must present low solubility with the gas to be evaluated and must not be reactive or dissolve the film. Afterwards, the gas cylinder (G) is opened to allow the gas that is being used to start flowing through the connections. Then the plunger driving system is actuated to generate gas bubbles; the gas flow must be low enough (approximately 0.001 ml/min) to guarantee the formation of a uniform bubble. When the system is operating, the film is placed over the liquid. Photographs are taken using camera (C) every so often, the time depending on the permeability to gas of the films being assessed. Images (photographs) are processed using ImageJ program, which allows to determine the bubble volume at various times.

In particular, Ayranci and Tunc (2003, “A method for the measurement of the oxygen permeability and the development of edible films to reduce the rate of oxidative reactions in fresh foods”. Food Chemistry, 80: 423-431) developed a method for determining oxygen permeability in edible films. The system is based mainly on ASTM standard method. The modification consists in the analysis of O₂, which is based on the analytic iodometric method. Ullsten and Hedenqvist (2003, “A new test method based on head space analysis to determine permeability to oxygen and carbon dioxide of flexible packaging”. Polymer Testing, 22: 291-295), proposed a technique for determining permeability to oxygen and carbon dioxide in flexible packages. This technique uses an analyzer of headspace gases to determine the contents of O₂ (a ceramic detector) and CO₂ (an infrared detector) inside the packages. The instrument was modified with a tube and a supplementary needle to recycle gas into the package.

Mondal et al., (2007, “Determination of oxygen permeability of polymers using in situ photo-generated heptacene”. Journal of Photochemistry and Photobiology A: Chemistry, 192: 36-40) determined permeability to oxygen in polymers. The method is based on the relationship between heptacene disappearance due to oxidation in the presence of oxygen. In patent U.S. Pat. No. 7,815,859, Kennedy and Erdori (2010, “Method and apparatus for determining the oxygen permeability of a polymer membrane”. http://patft.uspto.gov/netacgi/nph-Parser!Sect1=PTO2&Sect2=HITOFF&p=1&u=%2Fnetahtml%2FPTO%2Fsearch-adv.htm&r=1&f=G&I=50&d=PALL&S1=20080233006&OS=20080233006&RS=20080233006) of the University of Akron, developed an apparatus for measuring oxygen permeability of a polymer membrane, the apparatus comprising: an oxygen-donating enclosure, an oxygen-receiving enclosure coupled to the donating enclosure, a polymer membrane holding means, a means for measuring oxygen transport across the polymer membrane, data generation and determination of oxygen permeability of the polymer membrane.

Khoe at al., (2010, “Measurement of oxygen permeability of epoxy polymers”. ACI Materials Journal, 138-146) proposed a technique that improves and extends the range of measurements (largest thicknesses) for oxygen permeability of films. The new method is based on standard ASTM and CSRIO, The basic components of this system were maintained, that is to say, the diffusion cell and detectors; however, some modifications were made in the diffusion cell design to allow conducting tests with polymers with greater thicknesses such as fiber-reinforced polymer. For this reason, both the diffusion cell and the diffusion chamber are adjustable. An analytical technique was incorporated to determine coefficients of oxygen permeability.

Chowdhury et al., (2010, “Measurement of oxygen diffusivity and permeability in polymers using fluorescence microscopy”. Microscopy and Microanalysis, 16: 725-734) evaluated a method for determining oxygen diffusivity and permeability in different polymers (Teflon, polydimethylsyloxane). They proposed a technique with an inverted fluorescence microscope, so as to overcome the limitation of certain oxygen detectors that do not follow linearity of Stern-Volmer equation.

Shimoda et al., (2011, “Oxygen permeability measuring apparatus and method, and defect inspection apparatus and method”. United States Patent Application 20110244577 http://appft1.uspto.gov/netacgi/nphParser!Sect1=PTO1&Sect2=HITOFF&d=PG01&p=1 &u=/neta-html/PTO/srchnum.html&r=1&f=G&I=50&s1= developed an equipment for determining oxygen permeability in films. A container is charged with an inert gas and a chemiluminescent compound, and is also sealed with the film. A detector detects photons emitted b the chemiluminescent compound, in order to determine the amount of oxygen that permeates the barrier film.

Various methods have also been developed for determining oxygen concentration in packages as reported by U.S. Pat. No. 7,569,395 (Havens et al., 2009. “Method and apparatus for measuring oxygen concentration”. http://patft.uspto.gov/netacgl/nph-Parser!Sect2=PTO1&Sect2=HITOFF&p=1&u=/netahtml/PTO/search-bool.html&r=1&f=G&I=50&d=PALL&RefSrch=yes&Query=PN/7569395) and U.S. Pat. No. 7,749,768 (Havens and Barmore, 2011. “Non-invasive method of determining oxygen concentration in a sealed package”. http://patft.uspto.gov/netacgi/nph-Parser!Sect2=PTO1&Sect2=HITOFF&p=1&u=/netahtml/PTO/search-bool.html&r=1&f=G&I=50&d=PALL&RefSrch=yes&Query=PN/7749768), that are based on the exposure of a luminescent compound in an interior of the package, which is exposed to a light having a wave length that is absorbed by the luminescent compound so that the luminescent compound is excited. The excited luminescent compound emits a light that is detected by a detector positioned outside of the package. The intensity of the emitted light is inversely proportional to the oxygen concentration.

Although different studies and patents related to the determination of gas permeability in polymer films have been published, these have been focused on the search of alternatives to detectors of the different gases; however the equipment used is expensive and does not solve the other shortcomings of these determinations, such as: high times spent in measurements, and in the case of edible films, their exposure to dry gases for an extended time that makes the film become brittle, break during the assay and cause losses related to the time spent in reconditioning the equipment. There is also a need in the area of a method for determining gas permeability of polymer films that does not present the above stated difficulties or disadvantages.

### BRIEF DESCRIPTION OF THE FIGURES

FIG. 1 shows a schematic diagram of the system for determining gas permeability in polymer films.

FIG. 2 shows the measurements determined of the oxygen bubble, processed by ImageJ.

FIG. 3 shows the behavior of the bubble volume in the course of time.

### DETAILED DESCRIPTION OF THE INVENTION

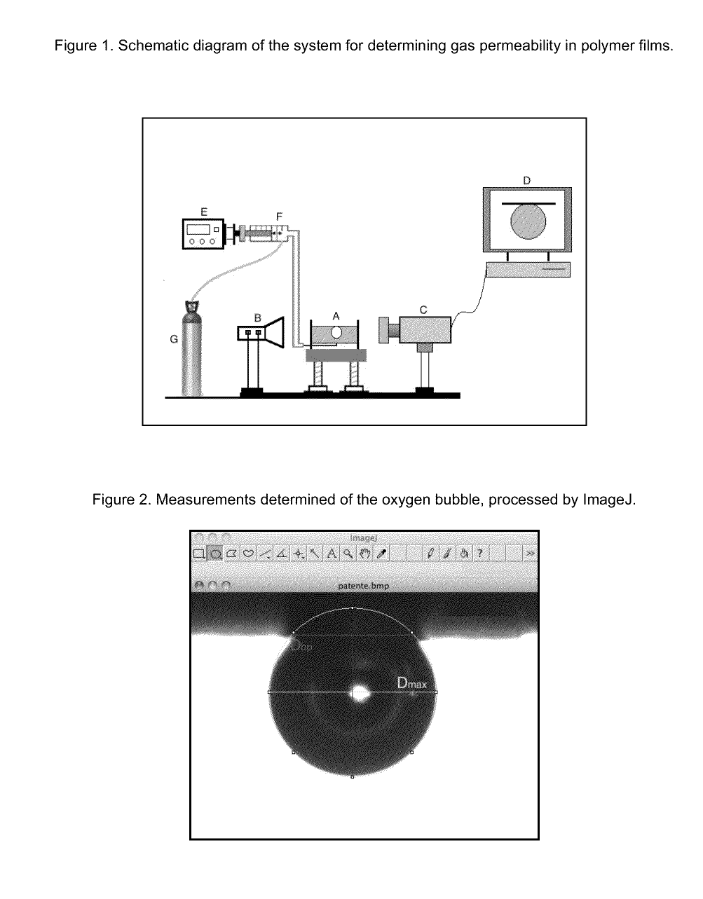

This invention consists in a system and method for determining gas permeability (see FIG. 1) in films, especially edible films, wherein the system comprises a receptacle (A) that contains the liquid, preferably water, means for generating gas bubbles comprising a cylinder that contains the gas (G), preferably oxygen, a driver, preferably a digital mechanical driver (E) that regulates gas flow and drives the syringe plunger (F), an image acquisition system comprising a high resolution camera (C), lighting (B), for which a lighting means, preferably a 60 W light bulb is used, and an image processing means, preferably a computer program (D).

To effect the determination of gas permeability (O₂, CO₂, N₂, air) in films, a liquid is placed in receptacle A; this liquid must exhibit low solubility of the gas being assessed and must not be reactive or dissolve the film (for example diiodomethane, for determining oxygen permeability in edible films based on starch). The gas cylinder (G) is then opened so that the gas being used may start to flow through the connections. Subsequently, the system that drives the syringe plunger is turned on to generate gas bubbles; the gas flow must be rather low (0.001 ml/min) to guarantee the formation of a uniform bubble. Once the system is operating, the film is placed over the liquid. Photographs are taken using camera (C) every so often, this depending on the permeability to gas of the films being assessed. Images (photographs) are processed is using the ImageJ program, which allows to determine the bubble volume at the different times. To this end, pixels that correspond to the maximum diameter of the bubble, the diameter of the contact area between the bubble and the film, and the bubble height are determined. These measurements are converted to mm or cm, according to a scale obtained by taking a photograph of a millimeter ruler. The bubble volume (V_{b}), the contact area between the bubble and the film (A_{bp}), the pressure inside the bubble (AP), gas transmission rate (for example, OTR if it is oxygen,) and film permeability (for example, OP if it is oxygen), are obtained using the following equations. In addition, the film thickness (e) is determined by means of a digital micrometer.

$$\begin{matrix}{V}_{b} = π {h}^{2 } ( R - \frac{h}{3} ) & ( 1 ) \\ {A}_{bp} = π {D}_{a}^{2} & ( 2 ) \\ Δ P = \frac{2 γ}{R} & ( 3 ) \\ OTR = \frac{Δ {V}_{b}}{{A}_{bp} Δ t} & ( 4 ) \\ OP = \frac{e * OTR}{Δ P} & ( 5 )\end{matrix}$$

wherein R is the bubble radius (Dₘ2), h the bubble height, Dₐ the diameter of the contact area between bubble and film (A_{bp}), γ is the surface tension of the liquid, ΔV_{b} is the bubble volume variation in a time interval (Δt) at a pressure, that is the relationship ΔV_{b}/Δt is the slope of the curve resulting from plotting V_{b} vs t, and e is the film thickness.

### Application Example

The oxygen permeability of a commercial film used for keeping fresh vegetables is determined. The procedure is as follows:

1. A film sample having a square shape with an area of about 4 cm² was taken and placed in receptacle “A”, which contained water, A being an acrylic receptacle.

2. The regulator of the oxygen cylinder was opened and this gas was circulated for 2 minutes to make sure that the air contained in the syringe and the hoses had been driven out.

3. The mechanical driver was actuated causing the syringe plunger displacement in order to generate a 0.001 ml/min flow, and guarantee a controlled bubble.

4. The lighting fixture was turned on and the camera was connected so as to focus the image of the oxygen bubble that had been generated. When a good image of the bubble was obtained, photographs of the bubble were taken every 15 minutes, for a period of 2 hours.

5. Once the photographs of the bubbles at the different times had been taken, a photograph of a millimeter ruler was taken to correlate the pixels of photographs of the bubbles with the pixels of the ruler, and determine in this way the bubble volume in mm³ and the contact area between bubble and film in mm ².

6. Details of the calculations are shown below.

6.1. FIG. 2 shows the bubble maximum diameter (Dₘₐₓ), height (h) and diameter of the contact area (Dₐ) between bubble and film; these were used in calculations of the bubble volume in mm³ and of the contact area between bubble and film in mm².

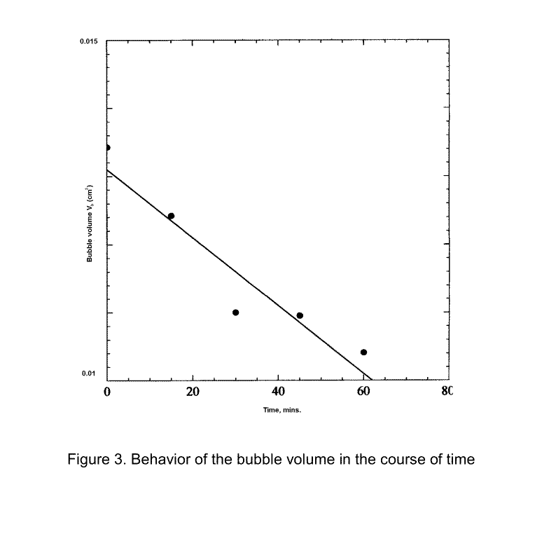

6.2. The pixels in the measurements obtained in FIG. 3 were converted to mm by using the scale obtained with the millimeter ruler that, for this example, corresponds to 5 mm, equivalent to 489 pixels.

6.3. The volume of the oxygen bubble was calculated according to equation 1 and the contact area between bubble and film, according to equation 2.

6.4. The pressure inside the bubble is determined using equation 3, bearing in mind that surface tension of the liquid used is 72.75×10⁻³ N/m (water).

6.5. Oxygen permeability of the film for fresh vegetables was calculated according to equation 4. The relationship ΔV_{b}/Δt was determined plotting V_{b} VS t, and calculating the curve slope. The summary of data and calculations is presented in Table 1. FIG. 2 shows the adjustment to a straight line (R²=0.91) of bubble volume data in the course of time, presenting a slope of −5.0×10⁻⁵cm³/min, wherein by replacing this value (positive, due to the fact that it was a decrease in volume in the course of time) and that of average A_{bp} (1.16527×10⁻⁵ m²), an OTR of 6180 cm³/m²·day is obtained, which corresponds to OTR value for this type of films as determined by ASTM method, which is 6900 cm³/m²·day, for a 10% difference.

The film presents a thickness of 30 μm, and with an average pressure of 71.06 Pa, replacing OTR value in equation 5, OP=2609.1 μm cm³/(m²·day·Pa) is obtained.

TABLE 1
Summary of oxygen permeability determination in films for fresh fruit and vegetables.

| Time, | Dmax, | Dmax, | h, | Volume, | D_{bp}, | D_{bp}, | A_{bp}, | Pressure, |
|---|---|---|---|---|---|---|---|---|
| min | pixels | mm | mm | cm³ | pixels | m | m² | Pa |
| 0 | 441 | 4.51 | 1.574 | 1.3468 × 10⁻² | 401 | 4.10E−3 | 1.3203 × 10⁻⁵ | 64.67 |
| 15 | 418 | 4.27 | 1.564 | 1.2400 × 10⁻² | 390 | 3.99E−3 | 1.2485 × 10⁻⁵ | 68.05 |
| 30 | 388 | 3.97 | 1.543 | 1.1000 × 10⁻² | 370 | 3.78E−3 | 1.1240 × 10⁻⁵ | 73.30 |
| 45 | 387 | 3.96 | 1.543 | 1.0963 × 10⁻² | 362 | 3.70E−3 | 1.0758 × 10⁻⁵ | 73.54 |
| 60 | 376 | 3.84 | 1.543 | 1.0403 × 10⁻² | 359 | 3.67E−3 | 1.0578 × 10⁻⁵ | 75.74 |

1. A system for determining a film permeability to gases selected from O₂, CO₂, N₂ or air by means of image acquisition, that it comprises a receptacle (A) that contains a liquid of low solubility for the gas to be determined (O₂, CO₂, N₂ or air), and not reactive to said gases; gas bubble generating means that comprise a cylinder containing the gas (G); a driver (E) that regulates gas flow and drives the syringe plunger (F); an image acquisition system that comprises a high resolution camera (C); lighting (B) for which a lighting means is used, and an image processing means (D).

2. The system of claim 1, wherein the receptacle (A) is an acrylic compartment.

3. The system of claim 2, wherein the liquid is water or diiodomethane.

4. The system of claim 1, wherein gas (G) is oxygen.

5. The system of claim 1, wherein the driver is a digital mechanical driver.

6. The system of claim 1, wherein the lighting means consists of a 60 W ht bulb.

7. The system of claim 1, wherein the image processing means is a computer programmed to process images.

8. The system of claim 1, wherein the film is a polymeric film.

9. The system of claim 8, wherein the film is an edible polymeric film.

10. The system of claim 9, wherein the film is an edible polymeric film based on starch.

11. Method for determining permeability of gases selected from O₂, CO₂, N₂ or air in a film, by means of image acquisition, that comprises:
a. placing in an receptacle a liquid with low solubility for O₂, CO₂, N₂ or air and not reactive to said gases, allowing gas (G) to flow, generating uniform bubbles in the liquid, and placing the film over the liquid;
b. taking photographs or images for a determined time range and frequency and with an auxiliary lighting means;
c. processing photographs or images in an image processing means, and determining change in the volume of the bubbles at different times, wherein the bubble volume is determined based on the pixels that correspond to the maximum bubble diameter (Dₘₐₓ), the diameter of the contact area between bubble and film (A_{bp}) and the bubble height (h);
d. correlating the number of pixels with a determined length measuring unit, and calculating variation in the gas bubble volume (ΔV_{b}), the contact area between the bubble and the film (A_{bp}), and the pressure inside the bubble (ΔP);
e. constructing the linear relationship of volume variation of the bubble in the course of time and from the slope of said linear relationship, calculating gas transmission rate (OTR), and then, permeability to gas.

12. The method of claim 11, that in stage (a) gas G flows at 0.001 ml/min.

13. The method of claim 11, that in stage (b) the lighting means consists of a 60 W light bulb.

14. The method of claim 11, wherein the time range determined from stage (b) shall depend on gas permeability in the film.

15. The method of claim 14, wherein stage (b) comprises taking photographs of the bubble every 15 minutes for a 2 hour time period, when the gas is oxygen and the film is for fresh vegetables.

16. The method of claim 11, wherein the image processing means is a computer programmed to process images.

17. The method of claim 11, that in stage (d), the length measuring units are cm or mm.

18. The method of claim 17, wherein 489 pixels correspond to 5 mm.
